(19) United States
(12) Patent Application Publication
(10) Pub. No.: US 2007/0093392 A1
(43) Pub. Date: Apr. 26, 2007

(54) Long lasting natural anti-pest additive

(75) Inventors: Frank A. Vavra, Linthicum, MD (US); Victor H. Klein III, Paxinos, PA (US); Steven R. Maimon, Alexandria, VA (US)

Correspondence Address: FOLEY AND LARDNER LLP;SUITE 500, 3000 K STREET NW, WASHINGTON, DC, 20007, US

(73) Assignee: Maxam Industires Inc.

(21) Appl. No.: 11/529,740

(22) Filed: Sep. 29, 2006

Related U.S. Application Data
(60) Provisional application No. 60/721,972, filed on Sep. 30, 2005.

(51) Int. Cl. A01N 25/12

(52) U.S. Cl. 504/367; 424/405

(57) ABSTRACT

Capsaicinoids that repel insects, reptiles, mammals, microorganisms and marine life are compounded with one or more ceramics or other inert material, into an environmentally friendly additive. The additive can be incorporated by extrusion, pultrusion, compression molding, casting or other suitable process into a wide range of products including, but not limited to, polymers, composites, paints, coatings, varnishes, shellacs, stains, sealants, preservatives, glues, adhesives, minerals, resins, latex, reinforced polymers, powders, foams and other similar classes of materials polymers, or combinations thereof. The repellency of the capsaicinoids remains effective for periods up to several years when the products are employed in their normal commercial uses.

### CROSS-REFERENCE TO RELATED PATENT APPLICATIONS

This application claims priority from Provisional Application U.S. Application 60/721,972, filed Sep. 30, 2005, incorporated herein by reference in its entirety.

### BACKGROUND

1. Field

Compounds having pest-repellent properties are ab/adsorbed by functional inert materials and incorporated into polymers, composites, paints, coatings, sealants, preservatives, glues, adhesives, minerals and other similar classes of materials, providing compositions having an effective repellency over an extended period of time in use against insects, reptiles, mammals, marine life, microorganisms and the like. Products incorporating the compositions are also described, which exhibit desirable, enduring anti-pest characteristics.

2. Background of the Technology

As an illustration of the many needs for an anti-pest additive, the agriculture industry is implementing improved above-ground and underground irrigation methods to conserve water and increase crop yields. One such method employs surface and subsurface drip irrigation (SDI) systems that provide regulated low water flow through flexible polymer (i.e., plastic) tubes. While the practical useful life of the polymer is typically 3 to 7 years in field applications, the actual functional life of such tubes is generally much less due to damage caused by rodents that gnaw on the tubes. The holes created by this gnawing result in too much water being released at points where the tube is damaged and too little water downstream from those points. Improper irrigation can affect the quality and yield of the crop, which is costly. Thus, to prevent such damage to the crops, the tubes may need to be repaired and/or replaced up to several times during a single growing season, which is labor intensive and costly.

Other examples of damage caused by insects, reptiles, mammals, marine life, microorganisms and the like, which adversely impact the performance and useful life of products, and require more frequent, and thus costly, maintenance, repair and replacement include:
rodents gnawing on wire and cable sheathing, thus damaging the wires and cables within;
termites and carpenter ants infesting and feeding on wood building and construction materials (e.g., plywood, oriented strand board, particleboard), thus damaging their structural integrity;
wasps and other flying stinging insects building nests on such materials, thus posing potential safety/health problems for humans and animals in the area of the nest;
roaches, silverfish, ants and other such insects feeding on and laying eggs on paper and cardboard products and the glues/adhesives that are used to manufacture them, thus damaging these products and potentially contaminating their contents;
marine boring worms infesting and feeding on wood pilings and other structures, thus damaging their structural integrity; and
Zebra mussels and barnacles colonizing, for example, on the intake/outflow pipes of power plants and waste treatment facilities, thus affecting their proper functioning.

Attempts by others to incorporate repellents into or applied to vulnerable products, so that long-lasting repellency is against insects, reptiles, mammals, marine life, microorganisms and the like have not generally been successful. For instance, previous attempts to incorporate the extracts of peppers in tubing failed because the polymers used to produce tubing do not readily ad/absorb extracts and the extracts leach out quickly. In general, one finds either the repellent is not released in sufficient amounts to deter pests effectively, and/or the repellent is lost too quickly into the environment to provide long-term protection.

The present additives contain large amounts of the active compounds ad/absorbed by selected particles that release the active compounds in effective amounts when pests threaten to damage the finished products in use. In addition, the selected particles serve to protect the active compounds from degradation during procedures used to process the ingredients, such as blending, compounding and extruding at elevated temperatures. These particle qualities permit one to manufacture finish products such as drip irrigation tubing that effectively repel pests for an extended period of time in commercial field applications, thus eliminating the labor and material cost of frequently replacing the tubes due to rodent damage. The risk of damage to crops due to the lack of sufficient water downstream from damaged tubing is also reduced.

U.S. Pat. No. 5,397,385 discloses an anti-fouling coating utilizing capsaicin as an active agent. The capsaicin may be provided as a powder made from finely divided particles of the dried habañero pepper, or may be provided as an oleoresin extract derived from commercially available oleoresin Capsicum. The capsaicin active ingredient, in whatever form, is found to readily separate from organic solvents used to disperse the capsaicin in commercially available abrasion resistant coating. Hence, an oleoresin capsaicin liquid solution is described, which is composed of capsaicin, silicon dioxide (i.e., silica gel), and organic solvent (e.g., methyl ethyl ketone, benzyl alcohol or isopropyl alcohol). This liquid solution is then mixed with an epoxy resin and hardening catalyst to provide a mixture that can be applied to a surface that requires protection. The commercially available abrasion resistant resin coating provided as an example contains 90% by weight of finely divided unnamed ceramic particles dispersed in 10% by weight Bisphenol A epoxy resin and an elastomer additive to enhance flexibility to the coating as applied. The ceramic particles are used solely to increase abrasion resistance. There is no discussion, teaching or suggestion of ab/adsorbing the active ingredient by ceramic particles and then dispersing the resulting ceramic particles in one or more solid or liquid carriers. In fact, the patent states explicitly at col. 9, lines 49-51, that “it should be understood that the ceramic particles are not required in the present anti-fouling coating.” (emphasis added)

U.S. Pat. No. 5,698,191 discloses a bio-repellent composition comprising a carrier, a capsicum oleoresin, and an amount of saponin sufficient to enhance the effectiveness of the capsicum oleoresin. In Example 3, an oil-in-water emulsion of oleoresin capsicum concentrate and 50% aqueous concentrate of saponin is incorporated into a flexible elastomeric acrylic water-based thermal barrier coating formulated with borosilicate ceramic particles. However, there is no disclosure, teaching or suggestion of a method that includes treating a ceramic filler with a solution comprising a pepper extract to ab/adsorb active ingredient by the ceramic particles, then combining the resulting ceramic particles with one or more solid or liquid carriers.

U.S. Pat. No. 5,997,894 discloses a coating composition and a method of forming the same in which the coating composition allegedly can withstand bites or attacks from animals, even squirrels with a biting power of 22,000 psi. Accordingly, ultra-fine, hard ceramic particles, like diamonds, nitrides and carbides, are chosen to enhance the hardness of the coatings. An exemplary coating composition is composed of ultra-fine, hard ceramic particles that are mixed with a binder to form a colloidal suspension, which is in turn added to a carrier. The resulting homogeneous mixture of colloidal suspension and the carrier is then incorporated into an elastomeric material to form a flexible coating. This patent states at col. 3, lines 22-24, that “aversive agents [such as Capsaicin or capsicum compounds] can be added to the coating composition or coated on after application of the coating composition . . . ” (emphasis added) Mixtures of ceramic particles, whiskers or fibers and binders are described, as already mentioned above, and claimed. The resulting colloidal suspensions are then added to oily or waxy carriers. Hence, there is no description, teaching or suggestion of ab/adsorbing active ingredient by the ceramic particles, which can then be combined with one or more solid or liquid carriers to produce an anti-pest additive. Likewise, there is no disclosure of articles of manufacture incorporating such anti-pest additives.

Other background references of potential interest include U.S. Pat. No. 5,492,696 and divisional U.S. Pat. No. 6,280,759, which disclose controlled release microstructures comprising tubules which contain an active agent in their lumen. U.S. Pat. No. 5,674,496 and divisional U.S. Pat. No. 5,985,010 disclose a substance and method for minimizing or eliminating damage to objects caused by animals. U.S. Pat. No. 5,891,919 discloses a capsaicin compound and a method of producing the compound. U.S. Pat. No. 5,925,370 discloses a bio-repellent matrix structure comprising a resin and first and second microspheres suspended in the resin. U.S. Pat. No. 6,465,022 discloses an essential oil extract of capsicum and methods of providing the extract. U.S. Pat. No. 6,638,621, continuation-in-part U.S. Pat. No. 6,482,517 and continuation-in-part U.S. Patent Publication No. 2003-0108743 disclose particles with an internal core comprising a matrix and an exterior coating. On the other hand, International Publication No. WO 96-28113 discloses a veterinary bandage having anti-chew properties comprising an elastic substrate, and an anti-chew substance. Shumake et al., J. Wildl. Manage., 64(4):2000, reported that capsaicin in a polybutylene carrier can reduce cable gnawing by wild Norway rats. The complete disclosures of the aforementioned references, as well as any others mentioned in this specification, are incorporated by reference herein.

### SUMMARY OF THE INVENTION

The invention is directed to a composition that contains at least one active ingredient, comprising: (i) ceramic particles in/onto which have been ab/adsorbed an effective amount of at least one active ingredient, and (ii) one or more solid or liquid carriers, the composition when incorporated into an article of manufacture comprised of the same solid or liquid carriers as in (ii), different solid or liquid carriers as in (ii), or combinations thereof, allows the article of manufacture to exhibit characteristics attributable to the presence of effective amounts of the at least one active ingredient for a period of at least about six months. The at least one active ingredient is ab/adsorbed in/onto the ceramic particles by contacting the ceramic particles with a liquid preparation comprising the at least one active ingredient. The adsorption step is carried out over a wide range of temperatures, from about ambient temperatures to elevated temperatures as high as 450 degrees Fahrenheit, depending on the application. In one embodiment of the invention, the at least one active ingredient comprises one or more repellent compounds. In another embodiment, the at least one active ingredient is selected from a fungicide compound, algeacide compound, pesticide compound, an anti-microbial agent, or combinations thereof.

A wide variety of ceramic particles can be utilized in the present invention. Examples of such ceramic particles include, but are not limited to, Alumina, Beryllium Oxides, Zirconia, Silicon Nitrides, Boron Carbide, Silicon Carbides, Tungsten Carbides, Silica-Alumina, or combinations thereof. The ceramic particles suitable for the invention generally have an average particle size ranging from about 5 to about 500 microns in diameter. Preferably, the ceramic particles have an average particle size ranging from about of 20 to about 150 microns in diameter and, more preferably, have an average particle size ranging from about of 40 to about 125 microns in diameter.

The choice of the one or more solid or liquid carriers can be quite varied. Generally, however, these one or more solid or liquid carriers are those which, in the absence of the ceramic particles, are regarded as incompatible with retaining the characteristics (e.g., repellent characteristics) that are attributable to the presence of effective amounts of the at least one active ingredient for a period of at least about six months. Examples of solid or liquid carriers include, carriers include, but are not limited to, polymers, composites, paints, coatings, varnishes, shellacs, stains, sealants, preservatives, glues, adhesives, minerals, resins, latex, reinforced polymers, powders, foams and other similar classes of materials polymers, or combinations thereof. However, the term “liquid carrier” does not include neat organic solvents, such as methyl ethyl ketone, benzyl alcohol, isopropyl alcohol and the like. Examples of solid polymeric carriers include, but are not limited to, Polycarbonate (PC), Polyethylene (PE), Polyvinylchloride (PVC), Polypropylene (PP), Polyphenylene Ether (PPE), Polyamide, Polyester, Polyimide, Polysulfone, Acrylonitrile-Butadiene-Styrene (ABS), Polycarbonate/Acrylonitrile-Butadiene-Styrene (PC/ABS), Acrylic-Styrene-Acrylonitrile (ASA), or their combinations.

In one embodiment, the active ingredient is provided as a liquid preparation, which in the case of a repellent compound preferably comprises a capsaicinoid compound extracted from pepper plants. In particular embodiments, the liquid preparation includes a zirconium phosphate-based ceramic ion-exchange resin containing silver, a silver sodium hydrogen zirconium phosphate, or an 2-iodo-2-propynyl butyl carbamate epoxy resin.

Articles of manufacture are also described in which the compositions of the invention have been incorporated including, but not limited to, a molded, cast, extruded or pulltruded polymer. In a particular embodiment of the invention, the concentration of the at least one active ingredient ranges from about 0.005 to about 5.0 wt % based on the total weight of the article of manufacture. Preferably, the concentration of the at least one active ingredient ranges from about 0.01 to about 1.0 wt % based on the total weight of the article of manufacture, and more preferably the concentration of the at least one active ingredient ranges from about 0.02 to about 0.5 wt % based on the total weight of the article of manufacture.

A process for the preparation of a composition containing at least one active ingredient is also disclosed, which comprises: (i) combining a preparation comprising at least one active ingredient with ceramic particles to form a first mixture; (ii) combining the first mixture with one or more solid or liquid carriers to provide a composition containing at least one active ingredient. In one embodiment of the invention the above-mentioned step (i), step (ii), or both steps are carried out at ambient temperature. On the other hand, step (i), step (ii), or both steps are carried out at elevated temperature. Still other variations can be contemplated in which one step is carried out at ambient temperature while the other step is carried out at elevated temperature.

Still another process for the preparation of a polymer composition containing at least one active ingredient is provided, which comprises: (i) combining a preparation comprising at least one active ingredient with ceramic particles to form a first mixture; (ii) combining the first mixture with one or more polymers at an elevated temperature to provide a molten mixture; (iii) optionally extruding or molding the molten mixture into a desired form; and (iv) allowing the molten mixture or the desired form to return to ambient temperature to provide a polymer composition containing at least one active ingredient. Such desired forms can come in many shapes and sizes. For instance, a form might comprise cylindrical rods that, in turn, can be further transformed into pellets. Moreover, such pellets can be combined with one or more polymers to form a second mixture. Such a second mixture might be subjected to an extrusion or pultrusion step, or to a compression molding, injection molding, blow molding, or casting step.

A method of making a composition containing at least one active ingredient is further described in which the method comprises: ab/adsorbing a liquid preparation comprising at least one active ingredient in/onto ceramic particles, and combining the ceramic particles in/onto which had been ab/adsorbed an effective amount of the at least one active ingredient with one or more solid or liquid carriers.

Consistent with the objectives of the invention, articles of manufacture are described in which have been incorporated an effective amount of a composition containing at least one active ingredient, the composition comprising (i) ceramic particles in/onto which have been ab/adsorbed an effective amount of the at least one active ingredient, and (ii) one or more solid or liquid carriers, the articles of manufacture being able to exhibit characteristics attributable to the presence of effective amounts of the at least one active ingredient for a period of at least about six months, preferably for a period of at least about nine months, more preferably for a period of at least about one year, and most preferably for a period of at least about two years or more, for example, for a period of at least about five years. Such articles can come in many forms, which are apparent depending on the application including, but not limited to plastic pipes, plastic tubes, plastic tapes, wiring insulation, cable jackets, cable liners, ground liners and covers and other sheets or films, or molded parts. The article of manufacture might also be a hard, flexible, or intumescent paint, coating, or sealant composition, to mention a few.

The invention also contemplates a method of inhibiting a pest from compromising the integrity of an article of manufacture, the method comprising: incorporating in an integral fashion into the article of manufacture ceramic particles in/onto which have been ab/adsorbed an effective amount of a preparation comprising at least one pest-control compound, which pest-control compound is released upon attack of the article of manufacture by a pest in amounts effective to deter the pest from damaging the article of manufacture or attacking it again. As mentioned earlier, the ceramic particles can be incorporated into the article of manufacture by extrusion or injection molding or other means. In a particular embodiment, the ceramic particles are first blended with one or more solid or liquid carriers to provide an additive. The additive may then be incorporated into the article of manufacture in an integral fashion, for example by extrusion or injection molding. The preparation preferably comprises a capsaicinoid compound extracted from pepper plants. An active ingredient, such as a pest-control compound might be selected from a fungicide compound, algeacide compound, pesticide compound, an anti-microbial agent, or combinations thereof.

### BRIEF DESCRIPTION OF THE FIGURES

FIG. 1 is a chart showing the results of an accelerated aging test.

### DETAILED DESCRIPTION OF THE PREFERRED EMBODIMENTS

Preferred ceramics are Alumina, Beryllium Oxides, Zirconia, Silicon Nitrides, Boron Carbide, Silicon Carbides, Tungsten Carbides, Silica-Alumina, or combinations thereof.

In a preferred embodiment the ceramic particles are porous microspheres. In another embodiment the particles have surface cavities sufficient to absorb effective amounts of, for example, an active repellent compound.

The ceramic particle size can vary from submicron to about 1,000 microns in average particle diameter. The typical particle size is 5 to about 500 microns in diameter, especially from about 20 to about 150 microns in diameter, with about 40 to about 125 microns in diameter being preferred. Whiskers or fibers of the above ceramic materials may also be used.

The active compound, including a solvent, if any, and ceramic particles are mixed by conventional methods known in the art, such as hand mixing or via a mechanical stirrer. Preferably, any solvent, if in use, is volatile and the adsorption process completed with the evaporation or removal of solvent. The amount of active compound ab/adsorbed in/onto the particles ranges from 0.1 to 50 wt %, especially 1.0 to 30%, and preferably 5.0 to 20%, based on the weights of the particles. The relative proportions are in the range of from about 20% to about 75% by weight active compound, from about 15% to about 50% by weight of solvent, and from about 10% to about 50% by weight of ceramic.

The amount of ceramic particles added to the repellent composition may be from about 0.5-75% by weight of the total coating composition (including paints, coatings, and sealants), depending on the desired composition, degree of flexibility, tensile strength, weight, elasticity and incurred cost desired. As the amount of ceramic particles is increased, the composition becomes less flexible, has less tensile strength, less elasticity, is heavier and costs more to produce. Preferably, the particles are present in an amount of from about 5.0-50% by weight of the total coating composition, and more preferably, from about 10-30% by weight of the total coating composition.

At high loading levels the active ingredient can be effectively retained in the finished product for periods from at least six months up to 1, 2, 3, or more years. The accelerated aging tests indicate the active life may be as much as 70 years. The estimated tubing life extension with the repellent additive is from 100% to 300% as compared to unprotected tubing.

Porous ceramic carriers not only absorb the active compound but protect it from the heat of polymer processes such as extrusion. The chemical nature of the ceramic is not important, just its physical structure. Other carriers can be used, such as talc and perlite, but these materials do not protect the active ingredient as well, so the final product does not last as long. The gritty nature of ceramic further to discourages rodents from chewing on the tubing as well.

Polymers such as polyethylenes, polypropylenes, styrenes, polyesters, polyurethanes, polyolefins, acrylics, phenolics, polyvinyl chlorides (PVC's), Teflons, nylons, rubbers, silicones and the like may be used. The polymer composition may be used as formed, or further processed by methods known in the art into sheaths for covering fiber optic cables, wires, pipes, hoses or other like substances.

Preferred polymers are Polycarbonate (PC), Polyethylene (PE), Polyvinylchloride (PVC), Polypropylene (PP), Polyphenylene Ether (PPE), Polyamide, Polyester, Polyimide, Polysulfone, Acrylonitrile-Butadiene-Styrene (ABS), Polycarbonate/Acrylonitrile-Butadiene-Styrene (PC/ABS), Acrylic-Styrene-Acrylonitrile (ASA), or combinations thereof. A preferred polymer is 2-iodo-2-propynyl butyl carbamate epoxy resin.

The treated ceramic particles may be combined, if desired, with a plasticizer, oil, wax, silicone, epoxy, polyurethane, mixtures thereof, or other like substances. The resulting mixture can be incorporated into a polymer, rubber, or other elastomeric material to form a flexible coating composition, wherein the elastomeric material is in an amount of from about 20-95% by weight of the total coating composition, preferably from about 50-90% by weight of the total coating composition.

In general, the treated ceramic particles are added to one or more solid or liquid carriers selected from, but are not limited to, polymers, composites, paints, coatings, varnishes, shellacs, stains, sealants, preservatives, glues, adhesives, minerals, resins, latex, reinforced polymers, powders, foams and other similar classes of materials polymers, or combinations thereof

Active repellent agents include Capsaicin or capsicum compounds and their derivatives, wintergreen compounds, denatonium compounds and their derivatives, Lidocaine compounds and their derivatives, Sucrose Octa Acetate, Brucine, like substances and mixtures. A preferred embodiment for the repellent is a liquid preparation comprising a capsaicinoid compound extracted from pepper plants.

The capsaicin may be provided in the form of an oleoresin extract derived from commercially available oleoresin Capsicum, such as an oleoresin product manufactured by Kalsec, Inc. of Kalamazoo, Mich. under the product name of “Oleoresin Capsicum, African type, 6% MC”. The later product is made from the dried fruit of Capsicum frutescens mixed with vegetable oils and contains 5.40% to 6.60% capsainoids. The capsaicin described herein may also be derived from highly pungent synthetic capsainoid compounds, such as capsaicin (C) and dihydrocapsaicin (DHC). Highly concentrated Oleoresin Capsaicin has a pungency rating in the range of from about 100,000 to about 3,000,000 Scoville Heat Units, with a range of from about 1,000,000 to about 1,500,000 being preferred. Pure capsaicin has a Scoville rating of about 16,000,000.

Fungicides or anti-microbial agents suitable for the invention include, but are not limited to, fungicide compounds and mildewcide agents such as PolyPhase P100 or Polyphase 641 (Troy Corp., New Jersey), or an antimicrobial agent, like AlphaSan RC 5000 (Milliken Corp., South Carolina).

Other aversive agents can be added to the composition in an amount of from about 0.001%-2.0% by weight of the total composition to provide a further deterrent to pest attack. Such aversive agents include zirconium phosphate-based ceramic ion-exchange resin containing silver and silver sodium hydrogen zirconium phosphate.

Once the treated particles and the matrix materials are combined, the polymer mixture is molded, cast, extruded or pulltruded by standard methods. “Pulltrusion” is a method of producing items like a continuous fiberglass sheet material where the fiberglas reinforcement is pulled through a resin bath and then a shaping die for curing. It produces a web similar to extrusion but including reinforcement fibers and can be used with thermoset resins and not just thermoplastics.

The repellent composition may be used to protect cables, wires, pipes and hoses. Further, it may be used to treat areas of buildings or dwellings likely to suffer from pest attack such as roofs, walls, paneling, siding, eaves and foundations, as well as other structures (such as utility and telecommunication cabinets, fences, etc.), by coating the surfaces with paints, coatings, sealants, varnishes, shellacs, stains, and the like, containing the repellent composition.

The article of manufacture exhibits pest-control, fungicide, algeacide, pesticide, an anti-microbial agent, or combinations thereof, characteristics for a period of more than six months as evidenced by an absence of damage to the article of manufacture, six months removed from its date of manufacture, when exposed in a caged environment for more than three weeks to one or more rodents. Accelerated aging tests have also been conducted in which articles of manufacture were exposed to 100° F. water over an 8-week period. Levels of active ingredient, which had leached out into the water, were measured after this 8-week period. The measurements showed that 0.002% of the amount of active ingredient (e.g., capsaicin) originally present in the articles of manufacture had leached out over this 8-week period. If the original amount of active ingredient was 1 wt % of the article of manufacture, and 0.002% of this content is expected to be lost over 8 weeks and a like percentage of any remaining active ingredient lost every 8 weeks thereafter, then the amount of time required to deplete the active ingredient from the article of manufacture is calculated to be over 70 years.

The concentration of the active ingredient ranges from about 0.005 to about 5.0 wt % based on the total weight of the article of manufacture, preferably from about 0.01 to about 2.0 wt %, and particularly from about 0.02 to about 1.0 wt % based on the total weight of the article of manufacture.

The ceramics can be mixed along with the active components into other materials like paints, coatings, varnishes, shellacs, stains, sealants, preservatives, glues, adhesives, minerals, resins, latex, reinforced polymers, powders, foams and other similar classes of materials. There the mixing takes place at ambient temperatures, and are ready to use once mixed without further processing. Formulated as a paint, the repellent composition of the invention can be used to treat outdoor furniture, fences, bird houses and bird feeders, screens and other items frequently subject to animal attack.

The following Examples are provided for illustrative purposes only, and are not intended to limit the scope of the invention. Alternative formulations and methods will be apparent to one of ordinary skill in the art. All materials are given in weight percent of the total composition unless otherwise specified.

### EXAMPLES

### Example 1

### Retention Through Processing

A repellent with a 1 million Scoville Heat Unit (SHU) rating was employed. The SHU is a measure of the capsaicinoid content of pepper extract (16 million SHU=100% capsaicinoid). The functional inert materials consisted of ceramic beads, activated carbon, and a paint pigment. Different ratios of repellent-to-functional inert material were employed in each case. The additives then were incorporated into samples of various types of products employing commercial extrusion and compression molding processes.

Polyethylene polymer matrices, which are representative of the most difficult types of products into which to incorporate the additives such that the potency of the repellents remains at effective levels in the products during the manufacture of the products and subsequently for extended periods of time during the commercial use of the products, were employed in most cases.

Similarly, extrusion processes, which subject the materials to very high shear stresses and temperatures during compounding of the additives into the products, and thus are representative of the types of conditions that potentially could affect adversely the potency of the repellents and force them out of the polymer matrices, also were employed in most cases.

The additive employing the paint pigment was blended in a controlled process directly into the paint along with a measured quantity of ceramic beads.

The samples of the products so produced were tested in a laboratory employing a liquid chromatograph to determine the quantity of capsaicinoids contained therein after processing. The following Table presents the results of the laboratory tests for representative samples of repellent/product combinations.

| | Composition (% of Total | | | | | | |
|---|---|---|---|---|---|---|---|
| | Formation) | | | | | | |
| | HDPE | 1 | | | | Lab Analysis | |
| | Melt | million | | Theoretical | | Measured | Measured |
| Sample | Index- | SHU | Ceramic | Capsaicin | | Capsaicin | Extract |
| Label | 22.0 | Extract | Beads | (%) | Processed | (%) | (%) |
| AP-3 | 10.0 lb. | 3.3 lb. | 6.7 lb. | 1.04% | Pelletized | 1.0% | 15.8% |
| | (50%) | (16.7%) | (33.3%) | | | | |
| AP-4 | 14.0 lb. | 2.0 lb. | 4.0 lb | 0.63% | Pelletized | 0.8% | 11.8% |
| | (70%) | (10%) | (20%) | | | | |
| AP-5 | | (3.0%) | 5% | 0.19% | Paint | 0.1% | 1.5% |

The variations between theoretical capsaicin content and measured capsaicin may be the result of measurement error and loss on evaporation of the volatiles in the paint sample (AP-5).

It was concluded from the test results that the potency of the repellents remains at effective levels in both the additives and the products during their manufacture employing the methods indicated above.

### Example 2

### Accelerated Aging

Anti-Pest Aging Study Results in Parts Per Million of Capsaicin

| | | Formula | Pellet | | | | | |
|---|---|---|---|---|---|---|---|---|
| Material | Description | level | analysis | Start | Week 1 | Week 2 | Week 4 | Week 8 |
| AP-3A | Injected | 10,400 | 13,000 | 0 | 25 | 21 | 17 | 8 |
| | extract | | | | | | | |
| | | 1.04% | 1.30% | 0 | 0.0025% | 0.0021% | 0.0017% | 0.0008% |

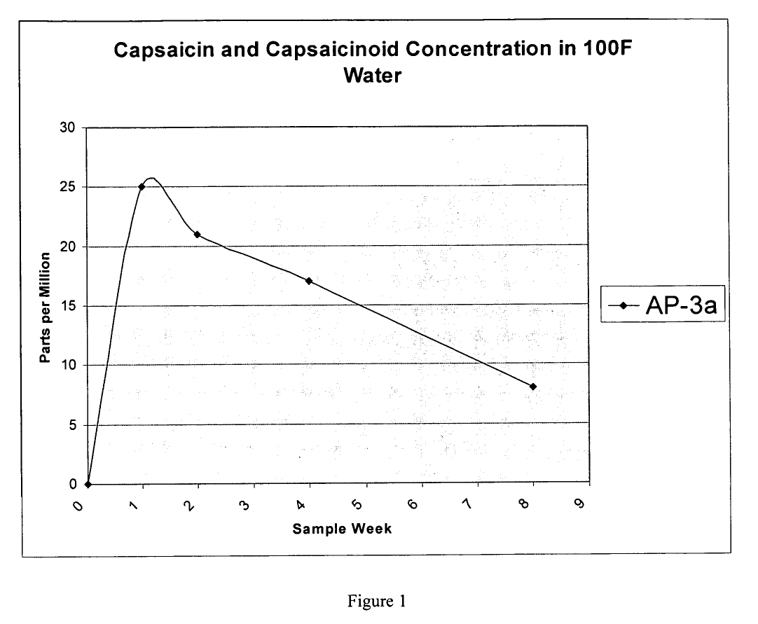

FIG. 1 is a chart showing the results of an accelerated aging test. Amounts of capsaicin lost to the water medium is shown by week for the test additive and is indicated in the table above. The AP-3a formulation included 1.04% capsaicin by weight (10,400 parts per million) in a polyethylene carrier as a concentrated additive in pellet form. The pellets were analyzed after production by liquid chromatograph and the amount of capsaicin was confirmed. Sample pellets were then placed in sealed ampules of water and maintained at a temperature of 100 degrees Fahrenheit for the time period indicated. The capsaicin content of the water was analyzed by liquid chromatograph at intervals and reported in parts per million. At a conservative release rate of 20 ppm over 8 weeks, the available capsaicin would last over 70 years

While the capsaicinoid concentration at the end of week 1 is higher than the level in week 2, this was expected as lightly bound capsaicinoid at the surface of the product samples is depleted. The stabilization of the capsaicinoid concentration in the hot water after week 1 implies retention of about 99.7% of the active capsaicinoid. While the translation of time under constant hot soaking to exposure to the elements in situ in commercial applications is not precise, extrapolation of the results indicate that the potency of the capsaicinoid should remain at an effective level in the range of at least 2-3 years in such applications, and potentially for decades, confirming the excellent properties and uniqueness of the invention.

### Example 3

### Protection from Rodent Damage to Thin Polyethylene (PE) Extrusions

Target

Screening tests: The effect of capsaicin on rodent repellency of treated PE extrusions.

Materials

1. Externally treated product—0.2 mm thickness.
1.1 Control—Thin extrusions made of HDPE black compound
1.2 Treated—Extrusions were coated with capsaicin solution. An oily extract containing 5% capsaicin was diluted in Hexane in ratio 1:4 (20%). Note: This experiment did not use the additives of the invention.

2. Product with additive of the invention

This extrusions—0.2 mm thickness, were prepared on a laboratory extruder:
2.1 Control—100% Black HDPE compound
2.2 90% black HDPE compound+10% AP 4 (Master-batch containing 0.63% capsaicin and providing 0.063% capsaicin in the extruded sample)
2.3 85% black HDPE+15% AP4 (Master-batch containing 0.63% capsaicin and providing 0.095% capsaicin in the extruded sample)
2.4 90% black HDPE+10% AP3 (Master-batch containing 1.04% capsaicin and providing 0.104% capsaicin in the extruded sample)
   Test Procedure

Four cages 50 cm×50 cm×50 cm were used. The following rodents species were placed in each cage.

1. Hamsters—5 adults

2. Gerbils—5 adults

3. Laboratory mice—5 adults

4. Laboratory rats—5 adults

Initially, tests were performed on thin untreated samples, and samples coated with capsaicin.

Rodents' food and water were supplied to the rodents in all cages. After 3 days of habituation, 2 pieces of 30 cm of control samples (untreated) were placed in the cages. Hamsters, mice and rats showed very limited activity towards the HDPE extrusions. Nothing happened except few bites during the first day. On the other hand, the gerbils were very aggressive towards the samples. The complete samples were converted to flakes within 24 hours.

Following this behavior pattern, it was decided to continue the test with gerbils only. Hence, gerbils were placed in all 4 cages, which contained 4 sample pieces, 40 cm long each were cut. In each sample 20 cm (half) was coated with the capsaicin solution, and placed in a cage.
24 hours later, the untreated half was completely converted to flakes, and the treated half was untouched.
The treated half was left in the cage, but food and drink were avoided. After 2 days biting started, and after 4 days, the sample was completely converted to flakes.
Supply of food and drink was resumed.
Control samples were placed again in the cages. They were converted to flakes within 24 hours.
40 cm long pieces were coated with 20% capsaicin oil in hexane solution, and placed in the cages.
0 bites were recorded during 5 days. After 7 days few bites were recorded at the edges. For additional 7 days nothing happened, and then, starting from day 11, 0.5-2 cm were nibbled every day. After 19 days 22 cm were left, and after 25 days the sample was fully destroyed.
A piece 30 cm long of each extruded sample containing the additive of invention was placed in a cage, with a control sample 30 cm long. The untreated sample was converted to flakes within 24 hours, while the treated samples were untouched for 3 weeks. At this stage the test was stopped.
   Discussion

From this information it is clear that capsaicin is very effective rodent repellent. The loss of activity for the coated samples as function of time may be related to: Loss of ingredient, loss of capsaicin activity or habituation.

The results showed that inclusion of capsaicin in the additive of the invention gave significantly better results than coating with active ingredient dissolved in neat organic solvent. The selection of method for capsaicin application may consider the following parameters: Effective concentration, Stability, Cost and Processability.

What is claimed is:

1. A composition containing at least one active ingredient, comprising:
(i) ceramic particles in/onto which have been ab/adsorbed an effective amount of at least one active ingredient, and
(ii) one or more solid or liquid carriers,
said composition when incorporated into an article of manufacture comprised of the same solid or liquid carriers as in (ii), different solid or liquid carriers as in (ii), or combinations thereof, allows said article of manufacture to exhibit characteristics attributable to the presence of effective amounts of said at least one active ingredient for a period of at least about six months.

2. The composition of claim 1 in which the at least one active ingredient is ab/adsorbed in/onto the ceramic particles by contacting the ceramic particles with a liquid preparation comprising the at least one active ingredient.

3. The composition of claim 1 in which the at least one active ingredient comprises one or more repellent compounds.

4. The composition of claim 1 in which the at least one active ingredient is selected from a pest-control agent, fungicide compound, algeacide compound, pesticide compound, an anti-microbial agent, or combinations thereof.

5. The composition of claim 1 in which the one or more solid or liquid carriers are, in the absence of the ceramic particles, incompatible with retention of characteristics attributable to the presence of effective amounts of said at least one active ingredient for a period of at least about twelve months.

6. The composition of claim 1 in which the one or more solid or liquid carriers are selected from polymers, powders, foams, paints, coatings, adhesives, resins, latex, fiberglass, or combinations thereof.

7. The composition of claim 2 in which the liquid preparation comprises a capsaicinoid compound extracted from pepper plants.

8. The composition of claim 2 in which the liquid preparation comprises a zirconium phosphate-based ceramic ion-exchange resin containing silver.

9. The composition of claim 2 in which the liquid preparation comprises silver sodium hydrogen zirconium phosphate.

10. The composition of claim 2 in which the liquid preparation comprises 2-iodo-2-propynyl butyl carbamate epoxy resin.

11. The composition of claim 1 in which the ceramic particles are selected from particles of Alumina, Beryllium Oxides, Zirconia, Silicon Nitrides, Boron Carbide, Silicon Carbides, Tungsten Carbides, Silica-Alumina, or combinations thereof.

12. The composition of claim 1 in which the ceramic particles have an average particle size ranging from about 5 to about 500 microns in diameter.

13. The composition of claim 1 in which the ceramic particles have an average particle size ranging from about of 20 to about 150 microns in diameter.

14. The composition of claim 1 in which the ceramic particles have an average particle size ranging from about of 40 to about 125 microns in diameter.

15. The composition of claim 1 in which the solid or liquid carrier is selected from a polymer comprising Polycarbonate (PC), Polyethylene (PE), Polyvinylchloride (PVC), Polypropylene (PP), Polyphenylene Ether (PPE), Polyamide, Polyester, Polyimide, Polysulfone, Acrylonitrile-Butadiene-Styrene (ABS), Polycarbonate/Acrylonitrile-Butadiene-Styrene (PC/ABS), Acrylic-Styrene-Acrylonitrile (ASA), or combinations thereof.

16. The composition of claim 1 which has been incorporated into a molded or cast polymer.

17. The composition of claim 1 which has been incorporated into an extruded or pultruded polymer.

18. The composition of claim 1 in which the concentration of the at least one active ingredient ranges from about 0.005 to about 5.0 wt % based on the total weight of the article of manufacture.

19. The composition of claim 1 in which the concentration of the at least one active ingredient ranges from about 0.01 to about 1.0 wt % based on the total weight of the article of manufacture.

20. The composition of claim 1 in which the concentration of the at least one active ingredient ranges from about 0.02 to about 0.5 wt % based on the total weight of the article of manufacture.

21. The composition of claim 1 in which the ceramic particles comprise Carbon Black.

22. A process for the preparation of a composition containing at least one active ingredient, comprising:
(i) combining a preparation comprising at least one active ingredient with ceramic particles to form a first mixture;
(ii) combining said first mixture with one or more solid or liquid carriers to provide a composition containing at least one active ingredient.

23. The process of claim 22 in which step (i), step (ii), or both steps are carried out at ambient temperature.

24. The process of claim 22 in which step (i), step (ii), or both steps are carried out at elevated temperature.

25. The process of claim 22 in which one step is carried out at ambient temperature while the other step is carried out at elevated temperature.

26. A process for the preparation of a polymer composition containing at least one active ingredient comprising:
(i) combining a preparation comprising at least one active ingredient with ceramic particles to form a first mixture;
(ii) combining said first mixture with one or more polymers at an elevated temperature to provide a molten mixture;
(iii) optionally extruding or molding the molten mixture into a desired form; and
(iv) allowing the molten mixture or said desired form to return to ambient temperature to provide a polymer composition containing at least one active ingredient.

27. The process of claim 26 in which the desired form comprises cylindrical rods.

28. The process of claim 27 in which the cylindrical rods are further transformed into pellets.

29. The process of claim 28 further comprising combining said pellets with one or more polymers to form a second mixture and subjecting said second mixture to an extrusion or pultrusion step.

30. The process of claim 28 further comprising combining said pellets with one or more polymers to form a second mixture and subjecting said second mixture to a compression molding, injection molding, or blow molding step.

31. A method of making a composition containing at least one active ingredient comprising:
ab/adsorbing a liquid preparation comprising at least one active ingredient in/onto ceramic particles, and
combining the ceramic particles in/onto which had been ab/adsorbed an effective amount of the at least one active ingredient with one or more solid or liquid carriers.

32. An article of manufacture in which has been incorporated an effective amount of a composition containing at least one active ingredient, the composition comprising (i) ceramic particles in/onto which have been ab/adsorbed an effective amount of the at least one active ingredient, and (ii) one or more solid or liquid carriers,
said article of manufacture able to exhibit characteristics attributable to the presence of effective amounts of said at least one active ingredient for a period of at least about six months.

33. The article of claim 32 in which said article of manufacture is able to exhibit characteristics attributable to the presence of effective amounts of said at least one active ingredient for a period of at least about nine months.

34. The article of claim 32 in which said article of manufacture is able to exhibit characteristics attributable to the presence of effective amounts of said at least one active ingredient for a period of at least about one year.

35. The article of claim 32 in which said article of manufacture is able to exhibit characteristics attributable to the presence of effective amounts of said at least one active ingredient for a period of at least about two years.

36. The article of claim 32 in which said article of manufacture is able to exhibit characteristics attributable to the presence of effective amounts of said at least one active ingredient for a period of at least about five years.

37. The article of claim 32 which is a plastic pipe, plastic tube, plastic tape, wiring insulation, cable jacket, cable liner, sheet, film, or molded part.

38. The article of claim 32 which is a paint composition.

39. The article of claim 32 which is a flexible coating composition.

40. A method of inhibiting a pest from compromising the integrity of an article of manufacture, comprising:
incorporating in an integral fashion into said article of manufacture ceramic particles in/onto which have been ab/adsorbed an effective amount of a preparation comprising at least one pest-control compound, which pest-control compound is released upon attack of said article of manufacture by a pest in amounts effective to deter further attacks.

41. The method of claim 40 in which said ceramic particles are incorporated into said article of manufacture by extrusion or injection molding.

42. The method of claim 41 in which said ceramic particles are first blended with one or more solid or liquid carriers to provide an additive.

43. The method of claim 42 in which an effective amount of said additive is incorporated into said article of manufacture in an integral fashion by extrusion or injection molding.

44. The method of claim 40 in which said preparation comprises a capsaicinoid compound extracted from pepper plants.

45. The method of claim 40 in which the pest-control compound is selected from a fungicide compound, algeacide compound, pesticide compound, an anti-microbial agent, or combinations thereof.
